(19) United States
(12) Patent Application Publication
(10) Pub. No.: US 2013/0037414 A1
(43) Pub. Date: Feb. 14, 2013

(54) CATALYST SYSTEM AND METHOD FOR THE PHOTOLYSIS OF WATER

(71) Applicants: Sigrid Obenland, Munich (DE); Christian Fischer, Pohlheim (DE)

(72) Inventors: Sigrid Obenland, Munich (DE); Christian Fischer, Pohlheim (DE)

(73) Assignee: CFSO GmbH, Greifenberg (DE)

(21) Appl. No.: 13/318,525

(22) PCT Filed: May 3, 2010
(86) PCT No.: PCT/EP10/02688

§ 371 Date: Jan. 26, 2012

(51) Int. Cl. C25B 1/04; C25B 1/06; C25B 9/00

(52) U.S. Cl. 205/340; 204/242

(57) ABSTRACT

A monolithic catalyst system for the cleavage of water into hydrogen and oxygen with the aid of light comprises a first photoactive material capable by itself or together with one or more of an auxiliary material and an auxiliary catalyst of generating oxygen and protons from water, when irradiated with light having a wavelength ≧420 nm of generating oxygen and protons from water, and a second photoactive material selected from gallium arsenide, copper indium disulphide/selenide, copper indium gallium disulphide/selenide and cadmium sulphide/selenide/telluride and having a water resistant coating transparent to visible light capable of the reducing protons in water to hydrogen, when irradiated with visible light. The first photoactive material and the second photoactive material are supported on at least one substrate and are in electrical contact, particularly in direct electrical contact, exclusively via one or more electron-conducting materials. The first photoactive material is not silicon, a III-V semiconductor or II-VI semiconductor or II-VI semiconductor or similar semiconductor having divalent or trivalent cations and anions of the groups Va and VIa of the periodic table of elements or semiconductor which is comprised of elements of the groups Ib (copper group), IIa, and VI or another inorganic photoconductor which is used in photovoltaic. Also disclosed is a process for cleaving water into hydrogen and oxygen with the aid of light using the catalyst system.

### FIELD OF THE INVENTION

The invention relates to a catalyst system for the cleavage of water into hydrogen and oxygen with the aid of visible light and to a method of producing hydrogen and oxygen using the catalyst system.

### PRIOR ART

Hydrogen is generally believed to become the material energy carrier of the future and thus there is a major interest in the environmentally friendly production of hydrogen without the concomitant production of carbon dioxide and without the use of conventional electrolysis which usually is expensive and often environmentally unfriendly.

In U.S. Pat. No. 6,936,143 B1 Graetzel et al. disclosed a tandem cell or photoelectro-chemical system for the cleavage of water to hydrogen and oxygen by visible light, both cells being connected electrically. This electrical connection involves an organic redox electrolyte for the transport of electrons from the photoanode, e.g. WO₃ or Fe₂O₃, to the photocathode, a dye sensitized mesoporous TiO₂ film. Although nothing is disclosed in this patent about the organic redox electrolyte, it is clear that the very term itself involves an electron transport through ionic conduction, since electrolytes always transport charge thorough ions.

### SUMMARY OF THE INVENTION

The present invention provides a monolithic catalyst system for the cleavage of water into hydrogen and oxygen with the aid of light, comprising a first photoactive material capable by itself or together with one or more of an auxiliary material and an auxiliary catalyst, when irradiated with light having a wavelength ≧420 nm, of generating oxygen and protons from water, and a second photoactive material selected from gallium arsenide, copper indium disulphide/selenide, copper indium gallium disulphide/selenide and cadmium sulphide/selenide/telluride and having a water resistant coating transparent to visible light capable of reducing protons in water to hydrogen when irradiated with visible light, the first photoactive material and the second photoactive material being supported on at least one substrate and being in electrical contact, particularly in direct electrical contact, exclusively via one or more electron-conducting materials,

with the proviso

that the first photoactive material is not silicon, a III-V semiconductor or II-VI semiconductor or II-VI semiconductor or similar semiconductor having divalent or trivalent cations and anions of the groups Va and VIa of the periodic table of elements or semiconductor which is comprised of elements of the groups Ib (copper group), IIa, and VI or another inorganic photoconductor which is used in photovoltaic.

Also provided is a method of generating oxygen and hydrogen from water with the aid of light and a catalyst system which is characterized in that a catalyst system in accordance with the invention is brought into contact with water or an aqueous fluid or solution at a first location comprising a first photoactive material or an auxiliary catalyst associated therewith or both and is brought into contact with water or an aqueous fluid or solution at a second location comprising the second photoactive material and the transparent water resistant coating via the water resistant coating and is then irradiated with light, the water or aqueous fluid or solution in contact with the first location and the water or aqueous fluid or solution in contact with the second location being in contact with each other such that protons can migrate from the first location to the second location.

Advantageous embodiments of the invention are recited in the dependent claims.

### BRIEF DESCRIPTION OF THE DRAWINGS

FIG. 1 depicts the so-called the Z scheme of photosynthesis or photolysis of water in plants or bacteria as used in the catalyst system in accordance with the invention.

FIG. 2 depicts a diagrammatic cross-section through an example of a catalyst system in accordance with the invention.

FIG. 3 depicts the UV/Vis spectrum of Mn₄O₄(phenyl₂PO₂)

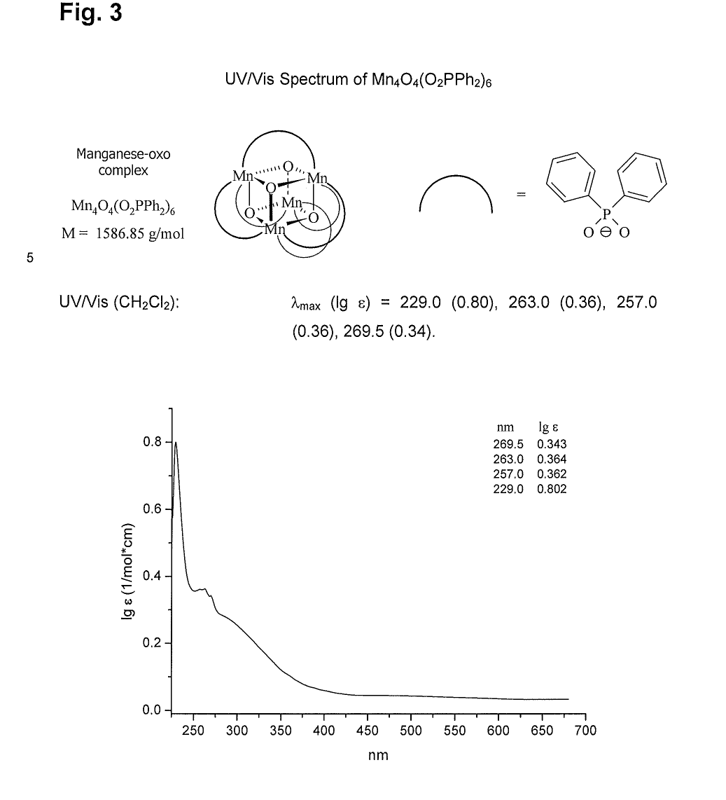

Principle of Generating Hydrogen and Oxygen According to the So-Called Z-Scheme

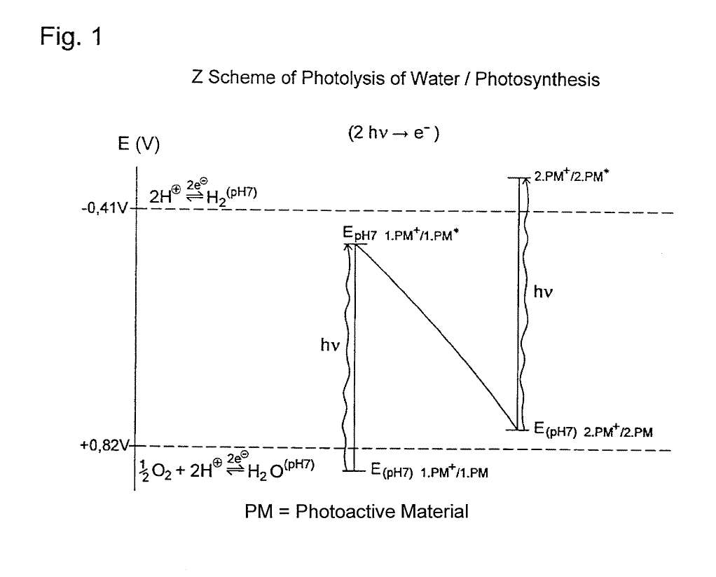

The catalyst system of the present invention uses four photons for the cleavage of water into ½O₂ and H₂. The various partial steps and how they relate by their energy levels are depicted diagrammatically in FIG. 1.

Required at the oxidizing side of the catalyst system (also termed first photoactive material hereinafter) are 2 photons for the following reaction

H₂O+2 photons→½ O₂+2 H⁺+2 e⁻(E_{O2/H2O(pH7)}=+0.82 V).

This is the reaction that takes place in plants/bacteria in the so-called photosystem 2.

Required at the reduction side of the catalyst system (also termed second photoactive material hereinafter) are 2 photons for the following reaction

2 H⁺+2 e⁻+2 photons→H₂ (E_{H+/H2(pH7)}=−0.41 V).

This is the reaction that may take place in some bacteria in the photosystem 1 in conjunction with the enzyme hydrogenase that generates hydrogen.

The net result of this reaction is:

H₂O+4 Photonen→H₂+½ O₂ (E_{pH7}=1.23 V).

What is involved is thus a process in which 2 photons (2 hν) are needed so that 1 e⁻ is removed from the oxygen in water and transferred to a H⁺ ion (2 hν→1 e⁻). This reaction is also termed Z scheme reaction according to photosynthesis in plants and bacteria.

The terms “hydrogen”, “protons”, “H⁺”, “H⁺ ions” etc. in conjunction with the present invention are also intended to include the terms “deuterium”, “deuterium ions”, “D+”, “D⁺ ions” etc. Likewise the term “H₂” is also intended to include “HD” and “D₂”. However, the term “D₂” does not include “HD” and “H₂”.

The electrons set free at the oxidation side of the catalyst system (in the terms of electrochemistry: the anode) in accordance with the invention are conducted directly to the reduction side of the catalyst system (in the terms of electrochemistry: the cathode) via one or more electron-conducting materials. Ion conductors, fluid redox electrolytes and solid electrolytes are not included in the term “electron-conducting material”. Electron conduction through junctions such as a p-n junction is not considered to involve an electron conducting material between a first and a second photoactive material in the sense of the present invention.

A monolithic catalyst system in this application is understood to be a system which is compact and has no structures such as macroscopic wires, conductors or electrodes extending from the system and not compactly integrated therein, e.g. no electrodes which are connected to the system via a conductive wire, band or sheet or the like. Such a monolithic system may take the form of a plate, a film or also a tube. “Monolithic” is not intended to mean that the system is necessarily fabricated as a single piece.

In accordance with the invention the first photoactive material is preferably not the complete photosystem 2, possibly modified, of plants or bacteria, (which thereby split water into oxygen and protons). It preferably particularly does not comprise polypeptides or proteins. The reason is that the natural photosystem 2 is very unstable.

The first photoactive material is not silicon, a III-V semiconductor or II-VI semiconductor or II-VI semiconductor or similar semiconductor having divalent or trivalent cations and anions of the groups Va and VIa of the periodic table of elements or a semiconductor which is comprised of elements of the groups Ib (copper group), IIa, and VI or another inorganic photoconductor which is used in photovoltaic.

The term “a first photoactive material” (which in the terms of electrochemistry is the anode of the photocatalyst system or forms part thereof) and “a second photoactive material” (which in the terms of electrochemistry is the cathode of the photocatalyst system or forms part thereof) is understood to also mean a plurality (or a mixture) of first photoactive materials and second photoactive materials, respectively.

A “first photoactive material” is understood in this patent application to be a material which together with the second photoactive material shows a redox potential scheme corresponding to the Z scheme of the photosynthesis/photolysis, the total potential difference of which is sufficient to permit cleavage water into hydrogen and oxygen when the photoactive materials are irradiated with light having a wavelength ≧420 nm, preferably ≧430 nm, more preferably ≧440 nm and particularly ≧450 nm. Furthermore, preferably the first photocatalyst should not exclusively absorb electromagnetic radiation at wavelengths ≧700 nm.

As evident from the Z scheme (see FIG. 1) the redox potentials of the first and second photoactive material comprise the following redox potentials and redox potential relationships:
1. The redox potential of the ionized state of the first photoactive material and the redox potential of the positively charged valence band of the first photoactive material, respectively, is more positive than +0.82 V.
2. The redox potential of the excited state of the second photoactive material and the redox potential of the conduction band of the second photoactive material, respectively is more negative than −0.41 V.
3. The redox potential of the excited state of the first photoactive material and the redox potential of the conduction band of the first photoactive material, respectively, is more negative than the redox potential of the ionized state of the second photoactive material and the positively charged valence band of the second photoactive material, respectively.

The redox potential of the non-excited state of the first photoactive material and of the valence band of the first photoactive material, respectively, is, as a rule more positive than the redox potential of the non-excited state of the second photoactive material and of the valence band of the second photoactive material, respectively.

Since the catalyst system is required to work with visible light having a wavelength ≧420 nm, the excited states and the conduction bands, respectively, of the photoactive materials must permit being generated or occupied with the aid of light of such a wavelength.

Of course, no external voltage has to be applied to the system in order to function.

A variety of materials, both in the form of non-molecular solids as well as molecular and polymer compounds, is known which may serve as the first photoactive (oxidation-promoting) material and work in light having a wavelength ≧420 nm. The first photoactive (oxidation-promoting) material may, however without being limited thereto, comprise an optionally doped oxide- and/or sulfide-containing material, in particular RuS₂, complexes or clusters containing a noble metal or an transition metal, and photoactive polymeric materials. For example and without limitation, use may be made of RuS₂ which may be doped, WO₃, which may comprise a noble metal, an iron oxide, which may be doped with foreign atoms, TiO₂ doped with Sb/M (M=Cr, Ni and/or Cu), a Mn4 cage complex, a Ru₄ cluster complex, a Ru³⁺ complex.

To facilitate development of oxygen the first photoactive material may be associated with an auxiliary material and/or auxiliary catalyst which itself is not a photoactive material as defined above, it instead promoting oxygen development without being able to develop oxygen by itself under irradiation. Such auxiliary materials and/ or catalysts are without limitation e.g. RuO₂, certain noble metals, such as palladium or platinum, or a compound formed in situ from cobalt metal and a phosphate in water.

In use of the catalyst system either the first photoactive material or the auxiliary material and/or catalyst, where existing, or both are in contact with water.

The second photoactive material is selected from gallium arsenide, copper indium disulphide/selenide (CIS), copper indium gallium disulphide/selenide (CIGS or simply CIS) and cadmium sulphide/selenide/telluride. Such materials are well-known to the person skilled in the art (see e.g. Richard H. Bube, Photovoltaic Materials, World Scientific Pub. Co. Inc. (1998); MRS Symposium Proceedings 0668: II-VI Compound Semiconductors, Ed. R. Noufi et al., Materials Research Society (2001); Richard Carter, Photovoltaic Systems, American Technical Publishers, Inc., Homewood (2009)) and are commercially available.

The second photoactive material is provided or coated with a water resistant coating transparent to visible light, which is capable of promoting the reduction of protons in water to hydrogen. Such a coating may e.g. comprise a very thin gold or gold alloy layer which is associated or alloyed with some platinum, palladium or nickel. Further useful materials which may be comprised by the coating are e.g. thin layers of water resistant conducting oxides, e.g. titanium oxide which may be modified with a metal (e.g. platinum or nickel) or indium-doped tin oxide (ITO) or a similar conducting water resistant oxide which is associated or modified with platinum, palladium or nickel.

The coating may be comprise two, three, four or even more layers, the inner layer(s) serving for capturing or separating the electrons from the second photoactive material and for transporting the electron further (n-type semiconductor) and the outer layer(s) for serving for protection from water and for assisting the reduction of the protons.

An example of a coating comprising two layers is a CdS₂-(optionally metal modified) TiO₂ (outer layer) coating. An example of a coating comprising four layers is a CdS₂—ZnO—ZnO/Al₂O₃—Au/Pt (outer layer) coating.

When in use the outer layer of water resistant coating of the second photoactive material is in contact with water.

The first and second photoactive material can be combined in accordance with the Z scheme (see above).

When the second photoactive (reduction-promoting) material is irradiated with light an electron thereof moves to an excited state from which—when the energy is sufficient—it is transferred to protons in the water (often with the aid of an auxiliary material or catalyst, e.g. Pt or Ru) resulting in hydrogen and a photoactive reduction-promoting material or second photoactive material with a hole or an oxidation state elevated by 1, respectively.

The cycle is closed when an excited electron from the first photoactive material is transferred to the oxidized second photoactive material and fills the hole therein.

Electron conduction in the catalyst system in accordance with the invention can be effected with one or more of all known electron-conducting materials. Electron-conducting materials are e.g. metals, alloys, semiconductors, conductive oxides, conductive polymers, but also so-called molecular wires (e.g. carbon or hydrocarbon chains or generally covalent bound branched or unbranched chains in a wealth of differing structures which may comprise one or more functional groups and exist in the form of substituents of a chemical compound or independently therefrom and are capable of conducting electrons) or so-called nanowires, [“wires” having a diameter of the order of a nanometer (10⁻⁹ meter) including metallic (e.g. Ni, Pt, Au), semiconducting (e.g. Si, InP, GaN etc) and in the macroscopic state isolating materials (e.g. SiO₂, TiO₂), as well as molecular nanowires composed of repeating units of either an organic (e.g. DNA) or inorganic nature (e.g. Mo₆S₉₋ₓIₓ). The electrons may also hop from molecule to molecule in certain material combinations.

In organic compounds or in ligands of complexes one or more of the functional groups thereof may be an optionally protected thiol group and the electron-conducting material to which the optionally protected thiol groups are bound may comprise gold.

For example, electron conduction from the first to the second photoactive material may take place via the conducting chain: nanocrystalline titanium dioxide/indium tin oxide (ITO)/copper/molybdenum. Of course, other conducting chains are conceivable.

When the first (oxidation-promoting) is an organic molecule or a complex with organic ligand(s) the conduction between the two photoactive materials usually includes an electron transition from an organic to an inorganic material or vice-versa, in the special case of a complex from the central atom of the complex via the ligand(s) to the conductive material or from the conductive material via the ligand(s) to the central atom of the complex.

This is usually no problem in the transition of an electron from the central atom to the ligand, and substituent(s) of the ligand are selected so that they are molecular wires. But the transition of an electron from the ligand or its substituent(s) for example to an inorganic conductor does not occur directly. Here, good results have been attained by introducing functional groups on the ligand or at the end of a ligand substituent capable of interacting with the inorganic material so strongly that electron conduction is possible. A prime example thereof is binding thiols to gold surfaces, although there is a wealth of other such interactions, e.g. those of phosphonic acids, carbon acid anhydrides or silanes to inorganic oxides (see e.g. an review thereof in the article by Elena Galoppini “Linkers for anchoring sensitizers to semiconductor nanoparticles” Coordination Chemistry Reviews 2004 248, 1283-1297).

The first (oxidation-promoting) photoactive material and the second (reduction-promoting) photoactive material may be mounted on or otherwise connected with one or more substrates (carriers), e.g. by physical deposition or some kind of by chemical bonding. The substrate may also be coated with an electrically conductive material, on which or with which the first (oxidation-promoting) photoactive material and the second (reduction-promoting) photoactive material may be mounted or otherwise connected, e.g. by physical or chemical deposition or some kind of by chemical bonding. The substrates may be electrically and photo-chemically inert, or not, and may be transparent or translucent (for instance glass) to permit the passage of light not absorbed by the photoactive material directly irradiated, or not. Non-limiting examples for the material of the substrate are optionally coated glass, ceramics, metal or metal alloys, semimetals, carbon or materials derived from carbon and all kinds of inorganic and organic polymeric materials.

With the aid of such a substrate a plane, e.g. plate-shaped, or also a tubular or otherwise appropriately shaped catalyst system can be constructed, e.g. with the photoactive oxidation-promoting material on one side and the photoactive reduction-promoting material on the other side, but also, when suitably structured, also with both materials on the same side. When the substrate is transparent or translucent it may be sufficient to irradiate one side of a plate-type catalyst system to also supply light to the photoactive material at the other side.

When a plane catalyst systems having the photoactive materials on opposite sides, for instance when plate-shaped, are immersed in an aqueous fluid, hydrogen is generated on one side and oxygen on the other. The way in which this is achieved already makes for hydrogen and oxygen being separated spatially, greatly diminishing the risk of an oxygen-hydrogen reaction. Totally separating the hydrogen from the oxygen is achievable by engineering the two photoactive materials totally separated from each other spatially, as is e.g. possible by compartmenting a reactor or reactor system into two chambers or into 2-chamber systems by means of a material exclusively permeable for protons and water (e.g. a Nafion® membrane). Protons must be able to drift to and fro between both chambers to compensate the charge.

The aqueous fluid into which the plane e.g. plate-type catalyst system of the present invention is immersed is normally water which may contain, depending on the case concerned, all kinds of soluble salts, acids or bases, but not by necessity. And, of course, e.g. mixtures of solvents and surfactants and the like soluble in water and, where necessary, watery emulsions and the like not involved in the photolysis reaction are a possible medium should it prove necessary, as long as the photolysis of the water is not disturbed or prevented thereby.

In the method of the invention the light used for irradiating the catalyst systems is preferably sunlight.

Furthermore, the first location and the second location irradiated are preferably separated from each other by a membrane permeable only for protons and water, e.g. a Nafion® membrane.

Only the first location of the catalyst system may be directly irradiated with light e.g. If the system is sufficiently transparent or partly transparent. Alternatively, only the second location may directly irradiated with light. In many cases, both locations are directly irradiated with light.

Oxygen and/or hydrogen evolving from water with the aid of the catalyst system and light may be intermittently or continuously collected.

The photocatalyst system in accordance with the invention has many advantages. Hydrogen and oxygen can be generated separately without production of oxygen-hydrogen gas. The system does not take the form of a powder but is monolithic, e.g. in the form of a plate which is simply immersed in an aqueous medium, requiring often no addition of any salts, acids or bases (although this is not excluded) which possibly add to the cost or environmental load of the method, all without the need of any special cells needing to be pressurized or involving a redox electrolyte which has to be encapsulated solvent-proof. The system is extremely flexible, featuring a large choice of water oxidizing catalysts (first photoactive materials) enabling suitable combinations to be tailor-made.

Structure of an Exemplary Catalyst System

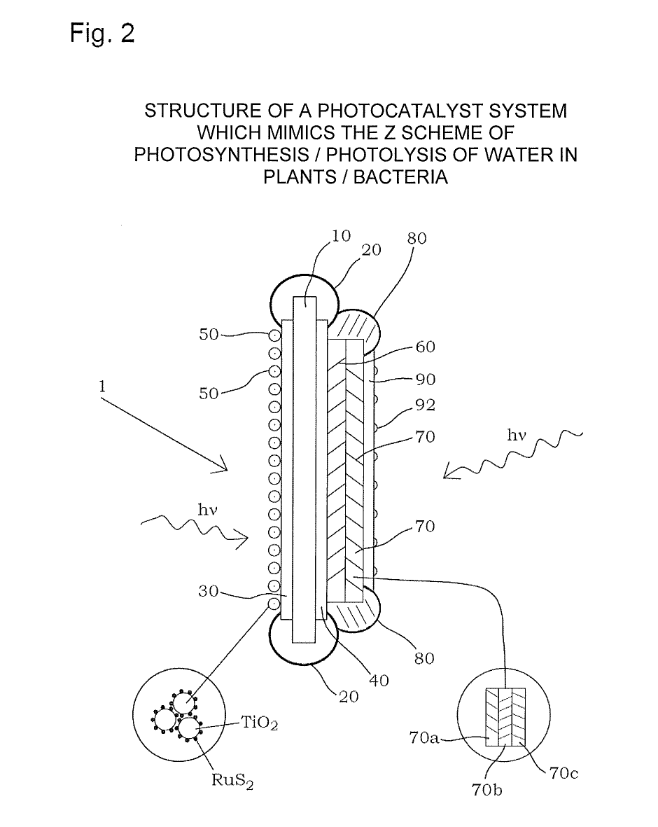

FIG. 2 depicts a diagrammatic cross-section through the configuration of a photocatalyst system 1 working analogously to the Z scheme, which features on one side of an inert plate-type substrate 10 consisting of two glass slides adhered together a transparent conductive indium-doped tin oxide (ITO) layer 30, on the other side a metal layer 40. The ITO layer 30 and metal layer 40 are electrically connected by copper bands 20.

Sintered on the ITO layer 30 is nanocrystalline TiO₂ 50 coated with RuS₂. Provided on the metal layer 40 is a copper indium gallium disulphide/selenide (CIGS) photosemiconductor 60, on which a multilayer 70 is deposited which comprises in order CdS₂ 70a, ZnO 70b and Zn/Al₂O₃ 70c. The edges of the multilayer 70 are framed on all sides by a resist 80 extending over the edge of the substrate 10 and covering the copper conductive adhesive tapes 20. Vacuum deposited on the multi 70 is a transparent thin gold layer 90 comprising just a few layers of gold and extending beyond the resist 80. Over the gold layer 90 a platinum layer 92 with fewer atoms of platinum than of a monolayer is deposited.

When the catalyst system as shown in FIG. 2 is immersed in water and irradiated with light having a wavelength ≧420 nm electrons originating from the oxygen atoms of the H₂O which has been oxidized to ½ O₂+2H⁺ migrate from the TiO₂ 50 coated with ruthenium disulfide via the ITO layer 30 and copper bands 20 to the metal layer 40. The photosemiconductor 60 on being irradiated has given off an electron via excitation of the electron into the conducting band and from there over the CdS₂ layer 70a, the ZnO layer 70b and Zn/Al₂O₃ 70c to the gold layer 90 and the platinum 92 where a proton (H⁺) in water is reduced by the electron to ½ H₂. The hole in the photoconductor thus generated is filled with the electron from the metal layer 40.

### EXAMPLES

The invention is further illustrated by the following non-limiting examples.

### Example 1

A. Preparation of a Oxidation-Promoting First Photoactive Material on TiO₂ in the Form of a 5% Suspension of TiO₂/RuS₂ (2% by Weight RuS₂ Relative to TiO₂)

Five grams of an aqueous TiO₂ suspension (10%, Aldrich) are diluted with 15 ml water and added with 23 mg (0.11 mmol) ruthenium(III)-chloride (RuCl₃), treated in an ultrasonic bath and concentrated under reduced pressure until dry.

The RuCl₃ deposited on the TiO₂ powder is firstly reduced to the metal (Ru) under an inert gas atmosphere in a stream of hydrogen gas (H₂). For this purpose the samples are heated to 300° C. and treated for 3 h in a flow of hydrogen at a rate of 50 ml/min. Then the temperature is elevated to 400° C. and 10 ml/min hydrogen sulfide are admixed; this initiates the sulfidation of Ru into black ruthenium sulfide (RuS₂) which is continued for a further 4 h [A. Ishiguro, T. Nakajima, T. Iwata, M. Fujita, T. Minato, F. Kiyotaki, Y. Izumi, K.-i. Aika, M. Uchida, K. Kimoto, Y. Matsui, Y. Wakatsuki, Chem. Eur. J. 2002, 8 (14), 3260-3268. / K. Hara, K. Sayama, H. Arakawa, Appl. Catal. A.: Gen. 1999, 189 (1), 127-137.]. This results in a gray powder which is then admixed in a quantity of 50 mg with 1 ml water and sufficiently suspended in the ultrasonic bath to give a light gray suspension of RuS₂ (2% by weight) on TiO₂.

B. Applying the Above Oxidation-Promoting First Photoactive Material to an ITO Substrate

Commercially available glass slides coated on one side with indium tin oxide (ITO) (available from PGO Präzisions Glas & Optik GmbH, Im Langen Busch 14, D-58640 Iserlohn, Germany) are thinly coated on the ITO side with an aqueous 10% TiO₂ suspension (from Aldrich, particle size<40 nm) and sintered for 60 min at 450° C., after which the aqueous 5% suspension of TiO₂/2% by weight RuS₂ as prepared above is coated and the slides resintered for 60 min at 450° C. under an inert gas atmosphere.

The resulting slide is designated Ox-I.

### Example 2

A. Preparation of Photoactive WO₃ Nanoparticles and Their Platinized Form as Oxidation-Promoting First Photoactive Materials

The preparation of photoactive WO₃ nanoparticles was performed according to literature procedures (J. Polleux, M. Antonietti, M. Niederberger, J. Mater. Chem. 2006, 16 (40), 3969-3975. / M. Niederberger M. H. Bartl, G. D. Stucky, J. Am. Chem. Soc. 2002, 124 (46), 13642-13643. / J. Polleux, N. Pinna, M. Antonietti, M. Niederberger, J. Am. Chem. Soc. 2005, 127 (44), 15595-15601.)

In a typical experiment tungsten hexachloride (WCl₆, 430 mg) was dissolved in 20 ml of anhydrous benzyl alcohol (or a mixture thereof with 4-tert.-butyl-benzylalcohol). The closed reaction vessel was heated at 100° C. with stirring for 48 hr. The product was collected by alternating sedimentation and decantation and washed three times with 15 ml EtOH. The material obtained was dried in air at 60° C. for several hours to yield a yellow powder of WO₃.

For an optional platinization, 50 mg of powder was suspended in a mixture of ethanol (50%) and water (50%). Pt cocatalyst (2% weight per WO₃) was deposited from a neutralized aqueous solution of H₂PtCl₆.6H₂O by a photodeposition method (K. Yamaguti, S. Sato, J. Chem. Soc. Faraday Trans 1 1985, 81 (5), 1237-1246. / T. Sakata, T. Kawai, K. Hashimoto, Chem. Phys. Lett. 1982, 88 (1), 50-54.)

B. Applying the Above Oxidation-Promoting First Photoactive Materials to an ITO Substrate

Quantities of 20 mg dry powder of platinized (grey) or non-platinized (yellow) catalyst were resuspended by ultrasonication in a mixture of 0.4 ml abs. isopropanol and 0.2 ml water (Suprapur). Small aliquots of each suspension were deposited on appropriate ITO-coated glass slides, respectively. The catalyst coated slides were air dried for 15 min and subsequently sintered at 450 h for 2 hr.

The resulting slide coated with plain WO₃ is designated Ox-IIa.

The resulting slide coated with platinized WO₃ is designated Ox-IIb.

### Example 3

A. Preparation of the Mn₄O₄ Oxo-Cubane Complex Mn₄O₄(phenyl₂PO₂) as a Oxidation-Promoting First Photoactive Material:

[On the basis of literature procedures: R. Brimblecombe, G. F. Swiegers, G. C. Dismukes, L. Spiccia, Angew. Chem. Int. Ed. 2008, 47 (38), 7335-7338. / T. G. Carrell, S. Cohen, G. C. Dismukes, J. Mol. Cat, A 2002, 187 (1), 3-15.]

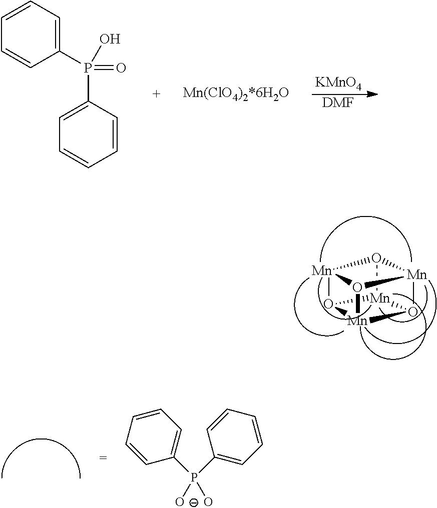

A solution of 60 mg NaOH (1.5 mmol) in 20 ml DMF is provided under inert gas atmosphere (N₂). 330 mg diphenyl phosphinic acid(1.5 mmol) and 255 mg manganese(II) perchlorate (0.7 mmol) dissolved in 8 ml DMF are added to the solution with vigorous stirring. After a reaction period of 15 min 50 mg KMnO₄ (0.3 mmol) dissolved in 18 ml DMF are slowly added dropwise through an addition funnel. A brownish red suspension is formed, which is stirred for 16 hr at RT. Die suspension is filtert, the residue washed with each of 40 ml of methanol and ether and dried. The title complex is obtained in the form of a brownish red powder.

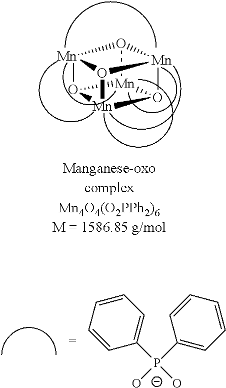

UV/Vis (CH₂Cl₂): λₘₐₓ (Ig ε)=229.0 (0.80), 263.0 (0.36), 257.0 (0.36), 269.5 (0.34).

UV/Vis spektrum: see FIG. 5

B. Applying the Above Oxidation-Promoting First Photoactive Material to an ITO Substrate in a Nafion® Matrix

The application of the above Mn₄O₄(phenyl₂PO₂) complex to an ITO-coated glass slide was effected on the basis of the following literature procedures: M. Yagi, K. Nagai, A. Kira, M. Kaneko, J. Electroanal. Chem. 1995, 394 (1-2), 169-175.

Commercially available glass slides coated on one side with indium tin oxide (ITO) (available from PGO Präzisions Glas & Optik GmbH, Im Langen Busch 14, D-58640 Iserlohn, Germany) are thinly coated on the ITO side with a 1 mM solution of the Mn₄O₄(phenyl₂PO₂) complex which was dissolved in a 1:1 mixture of Nafion® 117 solution and abs. Ethanol and dried for12 hr in air.

The resulting slide is designated Ox-III.

### Example 4

Providing a CIS Photosemiconductor as Reduction Promoting Second Photoactive Material

From a commercial photovoltaic plate without upper conductors (Avancis GmbH & Co. KG, Solarstr. 3, D-04860 Torgau, Germany) a plate having the same dimensions as the slides Ox-I, Ox-IIa, Ox-IIb and Ox-III was cut and the semiconductor layers over the metal on the substrate were carefully removed mechanically along the whole edge of the plate in a width of about 3 mm.

The resulting slide is designated Red.

### Example 5

A. Combining the Catalyst Units Comprising the First and Second Photoactive Material, Respectively, into a Catalyst System

The catalyst units produced above comprising each a oxidation-promoting first photoactive material (Ox-I, Ox-IIa, Ox-IIb and Ox-III) and the reduction-promoting second photoactive material (Red) are bonded together by their non-coated faces. The coated ITO surface of each of the Ox units and the exposed metal surface of the Red unit are conductively interconnected by a copper conductive adhesive tape (made by PGO Präzisions Glas & Optik GmbH, Im Langen Busch 14, D-58640 Iserlohn, Germany) with a small gap between the copper conductive adhesive tape and the semiconductor layer of Red. The edge of the Red unit is then coated with a resist so that the Cu bands, the exposed metal layer and edges of the semiconductor layer are covered. After having dried the assembled and conductively connected catalyst units the surface of the Red unit is vapor deposited with a very thin gold layer (5 nm) so that also the adjoining resist layer is covered. Finally, the catalyst system is completed by coating this gold layer with 0.5-0.7 monolayers (ML) of platinum.

The following combination s of catalyst systems are thus obtained:

Ox-I—Red

Ox-IIa—Red

Ox-IIb—Red

Ox-IIII—Red

B. Irradiating the Catalyst Systems

Each of the catalyst systems as made above was immersed into desoxygenated water (Suprapur) saturated with N₂. Then each catalyst system was irradiated from both sides with a 500 Watt tungsten halogen lamp through 420 nm cut-off filters. In each case oxygen and hydrogen developed which were detected in the head space filled with nitrogen above the water by means of gas chromatography.

The entire relevant disclosure of all documents cited in the present application, such as e.g. journal articles, books as well as patents and patent applications, is herein incorporated by reference.

1. A monolithic catalyst system for the cleavage of water into hydrogen and oxygen with the aid of light, comprising a first photoactive material capable by itself or together with one or more of an auxiliary material and an auxiliary catalyst when irradiated with light having a wavelength ≧420 nm of generating oxygen and protons from water, and a second photoactive material selected from gallium arsenide, copper indium disulphide/selenide, copper indium gallium disulphide/selenide, and cadmium sulphide/selenide/telluride and having a water resistant coating transparent to visible light capable of reducing of protons in water to hydrogen when irradiated with visible light, the first photoactive material and the second photoactive material being supported on at least one substrate and being in electrical contact, particularly in direct electrical contact, exclusively via one or more electron-conducting materials, with the proviso that the first photoactive material is not silicon, a III-V semiconductor or II-VI semiconductor or II-VI semiconductor or similar semiconductor having divalent or trivalent cations and anions of the groups Va and VIa of the periodic table of elements or semiconductor which is comprised of elements of the groups Ib (copper group), IIa, and VI or another inorganic photoconductor which is used in photovoltaic.

2. The monolithic catalyst system as set forth in claim 1, characterized in that the wavelength is ≧430 nm.

3. The monolithic catalyst system as set forth in claim 1, characterized in that the second photoactive material is selected from copper indium disulphide/selenide and copper indium gallium disulphide/selenide.

4. The monolithic catalyst system as set forth in claim 1, characterized in that the, or at least one, of the electron-conducting material(s) comprises a metal or metal alloy or an oxidic electron-conducting material.

5. The monolithic catalyst system as set forth in claim 1, characterized in that the first photoactive material is selected from one or more of an optionally doped oxide- and/or sulphide-containing material, complexes or clusters containing a noble metal or an transition metal, and photoactive polymeric materials.

6. The monolithic catalyst system as set forth in claim 1, characterized in that either the first photoactive material is bound by a functional group to the one or more electron-conducting material(s).

7. The monolithic catalyst system as set forth in claim 1, characterized by having a plane multilayer structure, wherein one side of the structure comprises the first photoactive material and the other side of the structure comprises the second photoactive material or one side comprises the first photoactive material and the second photoactive material.

8. The monolithic catalyst system as set forth in claim 1, characterized in that the water resistant coating transparent for visible light which is capable of promoting the reduction of protons to hydrogen is a transparent gold or gold alloy layer associated or alloyed with platinum, palladium and/or nickel, a transparent layer of titanium dioxide optionally modified with a metal or a layer of indium tin oxide (ITO) associated or modified with platinum, palladium and/or nickel.

9. A method of generating oxygen and hydrogen from water with the aid of light and a catalyst system which is characterized in that a catalyst system according to claim 1 is brought into contact with water or an aqueous fluid or solution at a first location comprising a first photoactive material or an auxiliary catalyst associated therewith or both and is brought into contact with water or an aqueous fluid or solution at a second location comprising the second photoactive material and the transparent water resistant coating via the water resistant coating and is then irradiated with light, the water or aqueous fluid or solution in contact with the first location and the water or aqueous fluid or solution in contact with the second location being in contact with each other such that protons can migrate from the first location to the second location.

10. The method as set forth in claim 9, characterized in that the light is sunlight.

11. The method as set forth in claim 9, characterized in that a monolithic catalyst system is used, the first location and the second location being separated from each other by a membrane permeable only for protons and water, and wherein the monolithic catalyst system is characterized by having a plane multilayer structure, wherein one side of the structure comprises the first photoactive material and the other side of the structure comprises the second photoactive material or one side comprises the first photoactive material and the second photoactive material.

12. The method as set forth in claim 9, characterized in that the first location is directly irradiated with light.

13. The method as set forth in claim 9, characterized in that the second location is directly irradiated with light.

14. The method as set forth in claim 9, characterized in that both locations are directly irradiated with light.

15. The method as set forth in claim 9, characterized in that oxygen and/or hydrogen are intermittently or continuously collected.
